(19) United States
(12) Patent Application Publication
(10) Pub. No.: US 2013/0193123 A1
(43) Pub. Date: Aug. 1, 2013

(54) METHOD FOR INSPECTING THE QUALITY OF A SOLDER JOINT

(71) Applicants: Jean-Christophe Saint-Martin, Autouillet (FR); Thierry Cembrzynski, Saint Cyr L'Ecole (FR)

(72) Inventors: Jean-Christophe Saint-Martin, Autouillet (FR); Thierry Cembrzynski, Saint Cyr L'Ecole (FR)

(73) Assignee: RENAULT s.a.s., Boulogne-Billancourt (FR)

(21) Appl. No.: 13/809,251

(22) PCT Filed: Jun. 24, 2011
(86) PCT No.: PCT/FR11/51469

§ 371 Date: Mar. 19, 2013

(30) Foreign Application Priority Data
Jul. 9, 2010 (FR) 1055589

(51) Int. Cl. G06F 17/18

(52) U.S. Cl. CPC G06F 17/18
USPC 219/121.63; 702/181

(57) ABSTRACT

A method for monitoring quality of a weld, includes implementing a probabilistic statistical model, for determining a rating of the quality of the weld.

The invention relates to a method for monitoring the quality of a weld and a device allowing the implementation of said method. The invention also relates to a device implementing such a method for monitoring the quality of a weld. The invention further pertains to a computer program suitable for the implementation of the method.

When it is produced correctly, a weld, or a weld bead, is a means which is widely used in industry to effect a strong and reliable join between two parts, in particular two metallic or thermoplastic parts. Strict and rigorous monitoring of the quality of the weld is essential to ensure a high level of performance and reliability of the join effected by means of the weld.

There are two contrasting categories of monitoring: destructive monitoring in which the welded join is unusable after monitoring and non-destructive monitoring in which the welded join is still usable after monitoring.

Among non-destructive monitoring, in a known manner, the weld bead is monitored by visual inspection by an operator, or by optical inspection in an automatic manner by a so-called profilometry monitor. Profilometry is a measurement scheme which consists in determining the profile of a surface, in this case the surface of the weld. Profilometry monitoring is effective, but it provides information only about the exterior appearance of the weld bead. The exterior appearance does not suffice to validate compliance of a laser bead. Moreover, in the case of the welding of thermoplastic parts, there is no modification of the exterior appearance.

Analysis of the temperature of the weld (pyrometry), more precisely, analysis of the temperature of the materials during welding, also allows monitoring of the quality of the weld. The signal representative of the temperature, subsequently called the temperature signal, is analyzed with the aim of detecting a possible defect in the weld, or indeed of identifying the type of defect generated involved. Various means making it possible to measure the temperature of the weld are known. A first known means comprises an infrared thermal camera, which provides an image representative of the temperature of the observed zone, the image being analyzed and processed with the aim of discerning a possible defect in the weld. A second known means making it possible to collect the temperature of the molten metal of the weld bead is the optical pyrometer. The optical pyrometer is a device which is able to sense the thermal radiation emitted by an element by means of a sensor and to provide a signal representative of the temperature of said element.

For the implementation of the two types of non-destructive monitoring mentioned above, the determination of weld compliance is done by placing alert thresholds on various characteristics of the weld. The definition of alert thresholds does not make it possible for welds to be classed in a robust manner into the classes “compliant”, “uncertain” and “non-compliant”.

Methods for monitoring the quality of a weld, wherein thermal data are acquired and then processed so as to determine whether the weld is compliant or non-compliant, are known for example from documents EP1 275 464 and EP1 361 015.

Also, a method for monitoring the quality of a weld is known from document EP 1 767 308, wherein radiation produced in the weld zone is detected and a mean and a standard deviation are used to rate the quality of the weld. Each new weld is then examined to see, as a function of its mean and of its standard deviation, how it ought to be rated. It should be noted that, in this method, a parameter must be supplied by a welding expert. Moreover, in this method, there is no training, it therefore requires good knowledge on the part of the operators that implement it. Each weld is now characterized only by a set of means and standard deviations. This method is applied solely to the welding of metallic materials.

Furthermore, a method for monitoring the quality of a weld, in which radiation produced in the weld zone is detected, is known from document EP1 555 082. The rating of the quality of the welds is done by analyzing the fourrier transform of the signal, which makes it possible to determine spurious frequencies, if any, which convey the presence of holes. This method is applicable solely to the welding of metallic materials. It is, moreover, difficult to implement industrially.

The aim of the invention is to provide a method for monitoring the quality of a weld making it possible to remedy the problems mentioned above and improving the methods for monitoring the quality of a weld that are known from the prior art. In particular, the invention proposes a method for monitoring quality making it possible to improve the robustness of the rating of the quality of a weld, and which may be implemented on various types of materials (not just metallic materials). The invention further pertains to a device for monitoring quality making it possible to implement such a method. More particularly, the invention pertains to a means for monitoring in real time, making it possible to evaluate the quality inside the weld. The invention further pertains to a computer program allowing the implementation of this method.

According to the invention, the method for monitoring the quality of a weld is characterized in that it implements a probabilistic statistical model, for determining a rating of the quality of the weld.

The statistical model may be a model of the logistic regression type.

The implementation of the model can make it possible to rate the quality of the weld as “compliant” or as “non-compliant” or possibly as “uncertain”.

The model can comprise a first module implemented to rate the quality of the weld as “non-compliant” or “perhaps compliant” and a second module implemented to rate the quality of the weld as “compliant” or “uncertain”.

The method can comprise a first phase of defining the model for rating the quality of the weld and a second phase of using the rating model to rate the quality of the weld.

The first phase can use profilometry data for the weld and/or temperature data for the weld and the second phase can use profilometry data for the weld and/or temperature data for the weld.

The first phase can comprise at least one of the following steps:
a step of carrying out weld trials,
a step of acquiring data relating to these welds,
a step of rating the quality of the weld trials,
a step of smoothing these data, the smoothing being for example carried out by way of breaks in mean,
a step of compressing the smoothed data and of extracting explanatory variables, the variables corresponding for example to the quantiles characteristic of the empirical distribution function of the smoothed data,
a step of using the explanatory variables to define the parameters of the model.

The second phase can comprise at least one of the following steps:
a step of producing a weld,
a step of acquiring data relating to the weld,
a step of smoothing these data, the smoothing being for example carried out by way of breaks in mean,
a step of compressing the smoothed data and of extracting explanatory variables, the variables corresponding for example to the quantiles characteristic of the empirical distribution function of the smoothed data,
a step of using the model, and
a step of rating the quality of the weld.

The invention also pertains to a data recording medium readable by a calculator on which is recorded a computer program comprising computer program code means for implementing the steps of the method defined above.

According to the invention, the device for monitoring the quality of a weld comprises hardware and/or software means for implementing the method defined above.

According to the invention, the welding installation comprises a monitoring device defined above and a welding device.

The invention also pertains to a computer program comprising a computer program code means adapted for carrying out the steps of the method defined above, when the program runs on a computer.

The appended drawing represents, by way of example, a mode of execution of a method for monitoring quality according to the invention and an embodiment of a device for monitoring quality according to the invention.

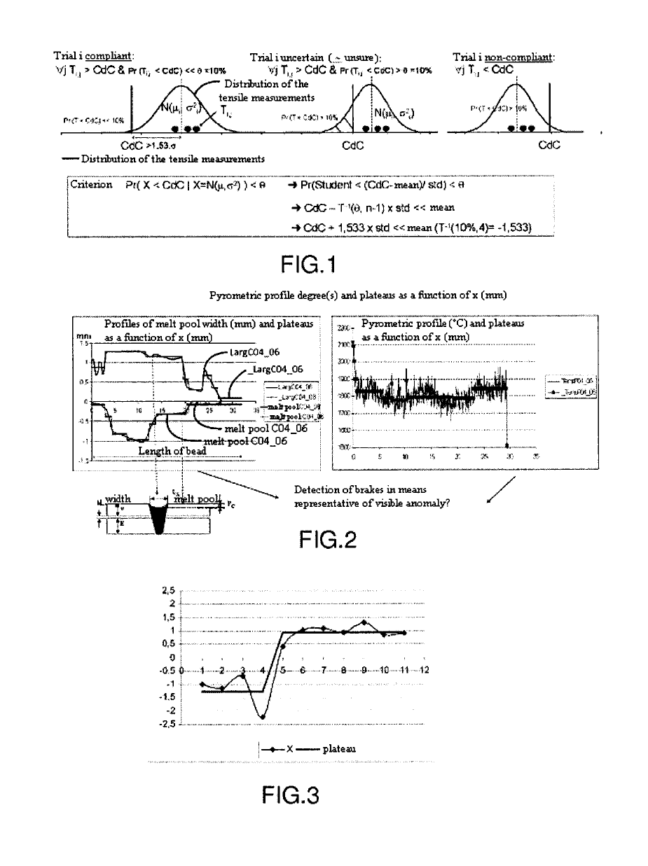

FIG. 1 is a diagram presenting a particular example of the statistical conditions making it possible to place weld trials as compliant, non-compliant or uncertain.

FIG. 2 is a set of graphs representing data characteristic of a weld and plateaus obtained for these characteristic data by implementing a step of an embodiment of the method for monitoring quality according to the invention.

FIG. 3 is a graph representing data and plateaus obtained for these data by implementing a step of an embodiment of the method for monitoring quality according to the invention.

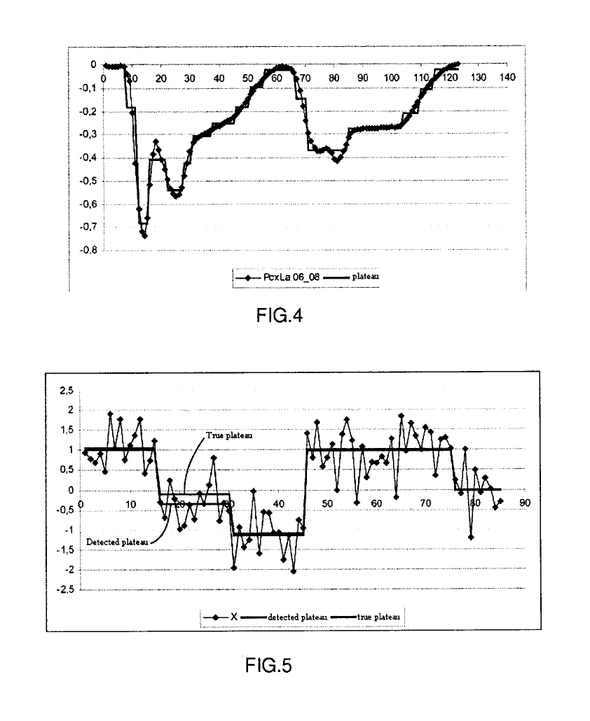

FIG. 4 is another graph representing profilometric data and plateaus obtained for these data by implementing a step of an embodiment of the method for monitoring quality according to the invention.

FIG. 5 is yet another graph representing data and plateaus obtained for these data by implementing a step of an embodiment of the method for monitoring quality according to the invention.

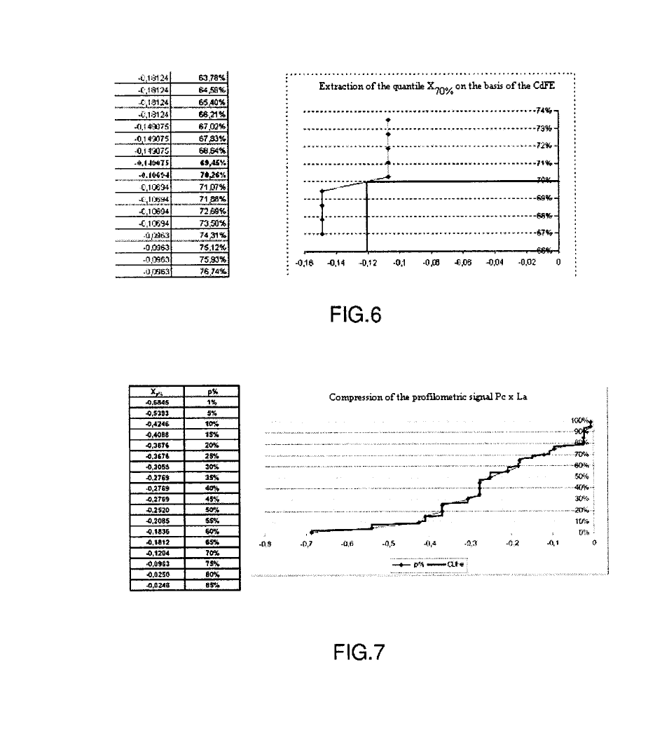

FIG. 6 is a graph illustrating a technique for compressing smoothed data, the compression being carried out by linear interpolation.

FIG. 7 is a graph illustrating the technique for compressing smoothed data of FIG. 6 applied to the smoothed data of FIG. 4.

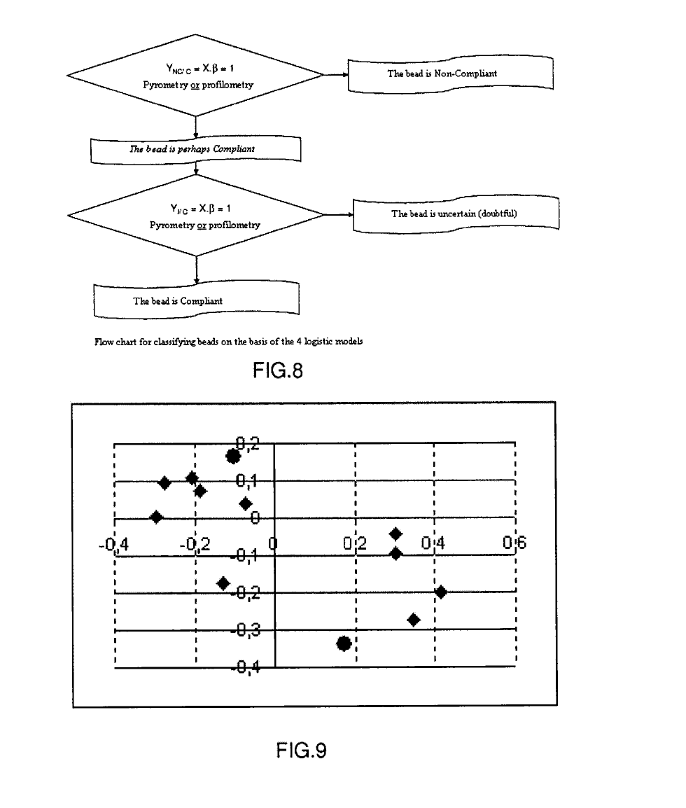

FIG. 8 is a decision flowchart explaining the logic for discriminating the quality of the weld.

FIG. 9 is an example of a series of 10 observations and responses associated with these 10 observations via the logistic model.

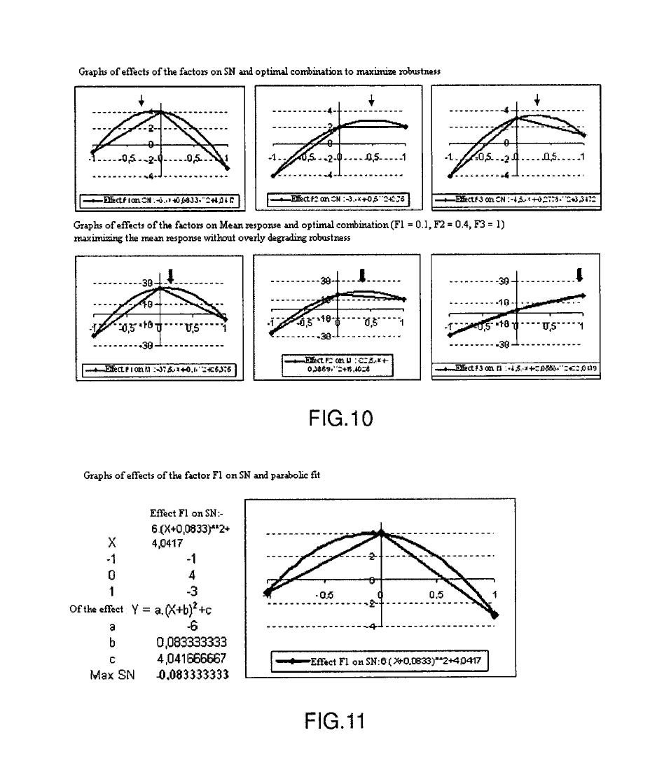

FIGS. 10 and 11 are graphs illustrating a training technique for the quality of the beads, validated by a scheme for the parabolic interpolation of the effects of various factors on a welding operation.

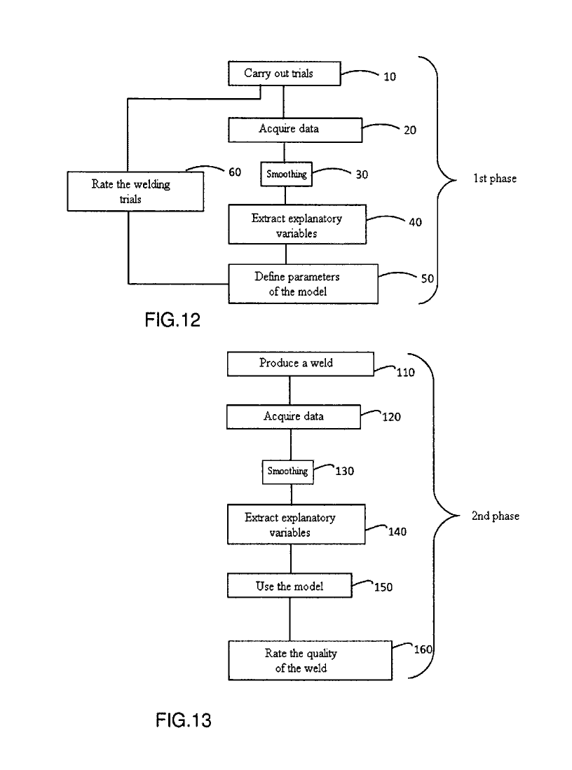

FIG. 12 is a flowchart of an exemplary execution of the first phase of the method for monitoring quality according to the invention.

FIG. 13 is a flowchart of an exemplary execution of the second phase of the method for monitoring quality according to the invention.

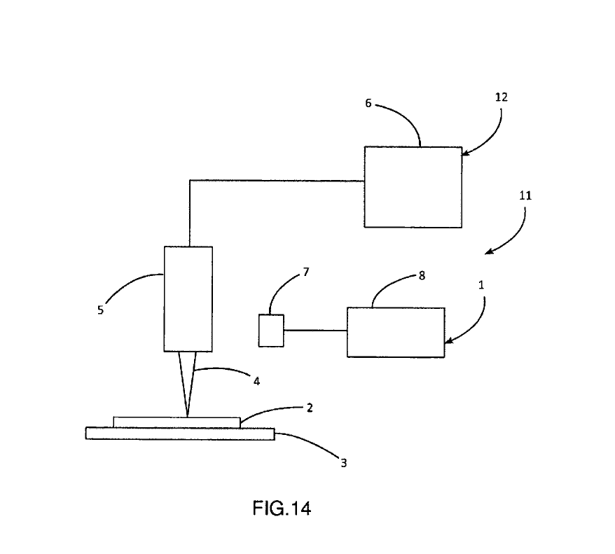

FIG. 14 is a diagram of an embodiment of a device for monitoring quality according to the invention.

According to the invention, the method for monitoring quality of a weld comprises two phases:
a first phase of defining a logic or a model for rating the quality of a weld, and
a second phase of using the rating logic or a model to rate the quality of the weld.

An embodiment of a method for monitoring quality of a weld according to the invention is described in detail hereinafter.

To industrialize, such a method for monitoring quality of a weld, it is necessary that the means for implementing the scheme be accessible to two types of users:
an engineer-technician who is in charge of the first phase mentioned above, that is to say of defining the rating logic so as to rate a weld, or, stated otherwise, of defining a model for discriminating the welds;
a user of the method who implements the second phase mentioned above, that is to say who uses the rating logic or the discrimination model. The user is typically situated on a production site such as a factory.

In a first step of the first phase, after having carried out weld trials, these weld trials are classed in one of the following three categories: “compliant”, “uncertain” and “non-compliant” on the basis of the measurements T_{i,j} of mechanical strength, such as measurements of tensile strength and of criteria CdC of mechanical strength which are given by a specification.

There are three possibilities of classing of the weld trials, for example:
1) Trial i compliant bead j: ∀j Ti,j>CdC AND Pr (Ti,j<CdC)<<θ=10%
2) Trial i uncertain (the beads are limits and the estimated non-compliance rate TNC>10%) bead j: ∀j Ti,j>CdC AND Pr (Ti,j<CdC)>θ=10%
3) Trial i non-compliant bead j: ∀j Ti,j<CdC

These three categories are illustrated in FIG. 1.

On the basis of a sample of n=5 measurements (or more preferably) for each trial:
trial i is declared compliant, if:

$$\{ \begin{matrix}{T}_{i , j} > CdC \\ CdC - {T}_{10 \%}^{- 1} ( n - 1 ) \times {s}_{i} \leq \overline{{x}_{i}}\end{matrix} \\ {s}_{i} = \sqrt{\frac{1}{n - 1} {\sum }_{j = 1}^{n = 5} {( {x}_{i , j} - {\overline{x}}_{i} )}^{2}} \overline{{x}_{i}} = \frac{1}{n} {\sum }_{j = 1}^{n = 5} {x}_{i , j} \\ {T}_{10 \%}^{- 1} = ( n - 1 ) = quantile at 10 \% > of Student ' s law with ( n - 1 ) degrees of freedom \\ {T}_{10 \%}^{- 1} ( 4 ) = - 1.533$$

trial i is declared uncertain, if the estimated non-compliance rate TNC is greater than 10% i.e. if:

$$\{ \begin{matrix}{T}_{i , j} > CdC \\ CdC - {T}_{10 \%}^{- 1} ( n - 1 ) \times {s}_{i} \leq \overline{{x}_{i}}\end{matrix}$$

trial i is declared non-compliant if:

∀ j T_{i,j}<CdC

In a second step, the scheme, for example Hinkley's test, is implemented to perform a smoothing by way of breaks in mean.

The aim of smoothing by way of breaks is to detect anomalies (for example holes) in signals of pyrometric and profilometric characteristics, measured in real time during welding. For example the measurement is performed by virtue of a laser camera.

For a weld bead, the analysis by way of breaks pertains (see FIG. 2):
1) in profilometry, to a measurement signal characteristic of the bead, for example melt pool depth or width;
2) in pyrometry, to the measurements Xᵢ of temperature i (in ° C.).

Smoothing by detecting breaks in mean of the profilometric and pyrometric signals measured by laser camera is aimed at diagnosing possible anomalies such as holes which could be spotted by eye by quality control monitors on the production site; then at filtering the spurious “natural variability” of the signal. The number of measurements of the signal depends on the length of the bead, and the sampling frequency.

Hinkley's scheme is based on the maximum likelihood for detecting a break in mean within a window of n observations, assumed Gaussian.

Consider a window of n observations {X₁, . . . , Xₙ} assumed Gaussian with mean μₒ and variance σ². Hinkley's test tests the appearance of a break in mean with variance assumed constant at observation Xᵣ.

$${H}_{o} ∀ i ∈ \{ 1 , … , n \} {X}_{i} = N ( {μ}_{o} , {σ}^{2} )$$

$${H}_{a} ∃ r ∈ \{ 2 , … , n \} \{ \begin{matrix}∀ i ∈ \{ 1 , … , r - 1 \} {X}_{i} = N ( {μ}_{1} , {σ}^{2} ) \\ ∀ i ∈ \{ r , … , n \} {X}_{i} = N ( {μ}_{2} , {σ}^{2} )\end{matrix}$$

The standard deviation a is estimated previously on n observations {Xᵢ, . . . , Xₙ} for example as the mean of two independent estimators:
1) the mean of the spans Wᵢ=|X₂ᵢ−X₂ᵢ₋₁| of two consecutive measurements {X₂ᵢ, X₂ᵢ₋₁}, taken relative to the mean span (1.128) of two observations arising from a reduced centered Gauss law (robust estimator);
2) the square root of the mean of the variances

$${s}_{i}^{2} = \frac{{( {X}_{2 i} - {X}_{2 i - 1} )}^{2}}{2}$$

of two consecutive measurements {X₂ᵢ, X₂ᵢ₋₁}.

$$σ = Mean ( \frac{1}{Ent ( n \text{/} 2 )} {\sum }_{i = 1}^{Ent ( n / 2 )} \frac{\vert {X}_{2 i} - {X}_{2 i - 1} \vert}{1.128} ; \sqrt{\frac{1}{Ent ( n \text{/} 2 )} {\sum }_{i = 1}^{Ent ( n / 2 )} \frac{{( {X}_{2 i} - {X}_{2 i - 1} )}^{2}}{2}} )$$

The most likely potential break point r is then sought.

The likelihood ratio RV may be written within the window {X₁, . . . , Xₙ}:

$$RV = \frac{V ( {H}_{o} )}{V ( {H}_{o} )} = \frac{\begin{matrix}{Π}_{i = 1}^{r - 1} \frac{1}{σ \sqrt{2 π}} exp ( - \frac{1}{2} {( \frac{{X}_{i} - {μ}_{1}}{σ} )}^{2} ) \times \\ {Π}_{i = r}^{n} \frac{1}{σ \sqrt{2 π}} exp ( - \frac{1}{2} {( \frac{{X}_{i} - {μ}_{1}}{σ} )}^{2} )\end{matrix}}{{Π}_{i = 1}^{n} \frac{1}{σ \sqrt{2 π}} exp ( - \frac{1}{2} {( \frac{{X}_{i} - {μ}_{1}}{σ} )}^{2} )}$$

$$Log ( RV ) = {\sum }_{i = 1}^{r} - \frac{1}{2} {( \frac{{X}_{i} - {μ}_{1}}{σ} )}^{2} + {\sum }_{i = r}^{n} - \frac{1}{2} {( \frac{{X}_{i} - {μ}_{2}}{σ} )}^{2} + {\sum }_{i = 1}^{n} \frac{1}{2} {( \frac{{X}_{i} - {μ}_{o}}{σ} )}^{2}$$

$$Log ( RV ) = \frac{( {μ}_{1} - {μ}_{o} )}{{σ}^{2}} {\sum }_{i = 1}^{r - 1} ( {X}_{i} - \frac{( {μ}_{o} + {μ}_{1} )}{2} ) + \frac{( {μ}_{2} - {μ}_{o} )}{{σ}^{2}} {\sum }_{i = r}^{n} ( {X}_{i} - \frac{( {μ}_{o} + {μ}_{2} )}{2} )$$

$$Log ( RV ) = [ ( r - 1 ) \times \frac{{( {μ}_{1} - {μ}_{o} )}^{2}}{2 \cdot {σ}^{2}} + ( n - ( r - 1 ) ) \times \frac{{( {μ}_{2} - {μ}_{o} )}^{2}}{2 \cdot {σ}^{2}} ]$$

In order to penalize the breaks at the edges of the window of the n measurements, this ratio is weighted by:

$$Log ( RVP ) = ( \frac{r - 1}{n} ) \times ( 1 - \frac{r - 1}{n} ) \times Log ( RV )$$

$$Log ( RVP ) = ( \frac{r - 1}{n} ) \times ( 1 - \frac{r - 1}{n} ) \times [ ( r - 1 ) \times \frac{{( {μ}_{1} - {μ}_{o} )}^{2}}{2 \cdot {σ}^{2}} + ( n - ( r - 1 ) ) \times \frac{{( {μ}_{2} - {μ}_{o} )}^{2}}{2 \cdot {σ}^{2}} ]$$

This makes it possible to favor breaks on long plateaus (rather at the center of the window) and to eliminate rogue breaks due to measurement errors or outlying data which would lead to plateaus of size 1 which present no interest.

The potential break point 2≦r≦n which maximizes the quantity Log(RVP) is retained. There is always one; the question is then to know whether it is relevant.

Accordingly, a step of validating the break point is put in place. A test of equality of the means (μ₁=μ₂) makes it possible to accept or to reject the assumption Ho of equality of the means at the potential break point r.

$$Under {H}_{o} T = \frac{{μ}_{1} - {μ}_{2}}{σ \times \sqrt{\frac{1}{r - 1} + \frac{1}{n - ( r - 1 )}}} = N ( 0 , 1 )$$

$${μ}_{1} = \frac{1}{r - 1} {\sum }_{i = 1}^{r - 1} {X}_{i}$$

$${μ}_{2} = \frac{1}{n - ( r - 1 )} {\sum }_{i = r}^{n} {X}_{i}$$

If

$$( Pr ( U > \vert T \vert ) \leq \frac{α}{2} = 0.135 \% \to$$

we reject Hₒ there is a break if we accept Hₒ there is no break

$$i . e . if \vert T \vert > {U}^{- 1} ( 1 - \frac{α}{2} ) = 3$$

U=reduced centered Normal Law

Detection is thereafter continued by appending k measurements, for example k=5. If the break is validated (Hₒ rejected), the plateau is ended on the sequence {1, . . . , r−1} and the detection procedure is repeated by appending a new sequence of k=5 measurements {Xₙ₊₁, . . . Xₙ₊ₖ} stated otherwise new breaks are sought in the series {Xᵣ, . . . Xₙ, Xₙ₊₁, . . . Xₙ₊ₖ}; doing so until the end of the data.

If the break is invalidated (Hₒ accepted), the detection procedure is repeated by appending a new sequence of k=5 measurements {Xₙ₊₁, . . . Xₙ₊ₖ} stated otherwise new breaks are sought in the series {X₁, . . . Xₙ, Xₙ₊₁, . . . Xₙ₊ₖ }; doing so until the end of the data.

An exemplary implementation of the above steps is described hereinafter.

Consider a series of n=11 observations {X₁, . . . , Xₙ} assumed Gaussian, these observations being summarized in the table hereinbelow.

| | Measurement No. | 1 | 2 | 3 | 4 | 5 | 6 |
|---|---|---|---|---|---|---|---|
| | X | −1 | −1.138 | −0.68 | −2.222 | 0.415 | 1.035 |
| | plateau | −1.26 | −1.26 | −1.26 | −1.26 | 0.93228571 | 0.93228571 |
| | | 1 | 1 | 1 | 1 | 1 | 1 |
| Estimation of the | span W [symbol] | | 0.138 | | 1.542 | | 0.62 |
| standard deviation | | | | | | | |
| | Variance s [symbol] | | 0.009522 | | 1.188882 | | 0.1922 |
| σ = Wbar/1.1 | 0.51560284 | | | | | | |
| σ = (s [symbol] | 0.5481498 | | | | | | |
| σ | 0.53187632 | | | | | | |
| risk α | 0.27% | | | | | | |

| | Measurement No. | 7 | 8 | 9 | 10 | 11 |
|---|---|---|---|---|---|---|
| | X | 1.104 | 0.939 | 1.293 | 0.85 | 0.89 |
| | plateau | 0.93228571 | 0.93228571 | 0.93228571 | 0.93228571 | 0.932285714 |
| | | 1 | 1 | 1 | 1 | |
| Estimation of the | span W [symbol] | | 0.165 | | 0.443 | |
| standard deviation | | | | | | |
| | Variance s [symbol] | | 0.0136125 | | 0.0981245 | |
| σ = Wbar/1.1 | 0.51560284 | | | | | |
| σ = (s [symbol] | 0.5481498 | | | | | |
| σ | 0.53187632 | | | | | |
| risk α | 0.27% | | | | | |

[symbol]

indicates data missing or illegible when filed

We adopt σ=0.531 as mean estimator of the two independent estimations of the standard deviation:
the mean of the spans Wᵢ of two consecutive measurements {X₂ᵢ, X₂ᵢ₋₁}, taken relative to the mean span (1.128) of two observations arising from a reduced centered Gauss law (0.515);
the square root of the mean of the variances sᵢ² of 2 consecutive measurements {X₂ᵢ, X₂ᵢ₋₁} (0.548).

A first window of k measurements is analyzed, k=5. i.e. the first window of n=5 observations {X₁, . . . , Xₙ}:

| | break point | | | | | |
|---|---|---|---|---|---|---|
| | N ≧ r > 1 | 1 | 2 | 3 | 4 | 5 |
| | series of | | | | | |
| | measurements | −1 | −1.138 | −0.68 | −2.222 | 0.415 |
| μ₀ | −0.925 | | | | | |
| nobs | 5 | | | | | |
| μ₁ | | −1 | −1.069 | −0.9393333 | −1.26 | |
| n₁ | | 1 | 2 | 3 | 4 | |
| μ₂ | | −0.90625 | −0.829 | −0.9035 | 0.415 | |
| n₂ | | 4 | 3 | 2 | 1 | |
| LPRV | | 0.00198839 | 0.02931998 | 0.00065361 | 0.63472893 | |
| (! μ₁ − μ₂!/ | | | | | 2.81675551 | |
| σ · (1/n₁ + | | | | | | |
| 1/n₂)\hat{ }0.5) | | | | | | |

| | |
|---|---|
| BREAK? 1/0 | 0 |

The potential break point r is determined at r=5, with a maximum value of the weighted likelihood ratio LPRV=0.6347.

The test

$$value T = \vert \frac{{μ}_{1} - {μ}_{2}}{σ \times \sqrt{\frac{1}{r - 1} + \frac{1}{n - ( r - 1 )}}} \vert$$

is then 2.8167, the assumption of equality of the means (absence of break) Hₒ is then accepted (T<U⁻¹(1−α/2)=3).

Thereafter a second window of k measurements is analyzed, k=5. The second window comprises n=10 observations {X₁, . . . , Xₙ}:

| | Break point | | | | | |
|---|---|---|---|---|---|---|
| | N ≧ r > 1 | 1 | 2 | 3 | 4 | 5 |
| | Series of | −1 | −1.138 | −0.68 | −2.222 | 0.415 |
| | measurements | | | | | |
| μ₀ | 0.0596 | | | | | |
| nobs | 10 | | | | | |
| μ₁ | | −1 | −1.069 | −0.9393333 | [symbol] | −0.925 |
| n₁ | | 1 | 2 | 3 | 4 | 5 |
| μ₂ | | 0.17733333 | 0.34175 | 0.48771429 | [symbol] | 1.0442 |
| n₂ | | 9 | 8 | 7 | 6 | 5 |
| LPRV | | 0.19844154 | 0.9005105 | 1.58731902 | [symbol] | 4.28359468 |
| (! μ₁ − μ₂!/ | | | | | 6.40598658 | |
| σ · (1/n₁ + | | | | | | |
| 1/n₂)\hat{ }0.5) | | | | | | |
| BREAK? 1/0 | | | | | 1 | |
| | Break point | | | | | |
| | N ≧ r > 1 | 6 | 7 | 8 | 9 | 10 |
| | Series of | 1.035 | 1.104 | 0.939 | 1.293 | 0.85 |
| | measurements | | | | | |
| μ₀ | 0.0596 | | | | | |
| nobs | 10 | | | | | |
| μ₁ | | −0.5983333 | −0.3551429 | −0.193375 | −0.0282222 | |
| n₁ | | 6 | 7 | 8 | 9 | |
| μ₂ | | 1.0465 | 1.02733333 | 1.0715 | 0.85 | |
| n₂ | | 4 | 3 | 2 | 1 | |
| LPRV | | 2.7543237 | 1.48971301 | 0.72390884 | 0.11041868 | |
| (! μ₁ − μ₂!/ | | | | | | |
| σ · (1/n₁ + | | | | | | |
| 1/n₂)\hat{ }0.5) | | | | | | |

BREAK? 1/0

[symbol]

indicates data missing or illegible when filed

The potential break point r is determined at r=5, with a maximum value of the weighted likelihood ratio LPRV=4.9243.

The test value

$$T = \vert \frac{{μ}_{1} - {μ}_{2}}{σ \times \sqrt{\frac{1}{r - 1} + \frac{1}{n - ( r - 1 )}}} \vert$$

is then 6.405, the assumption of equality of the means (absence of break) Hₒ is then rejected (T>>U⁻¹(1−α/2)=3).

The plateau is ended on the sequence {1, . . . , r−1} the mean of which has been estimated at μ₁=−1.26.

Thereafter a third window is analyzed on the basis of the point r=5 after appending k measurements, k=1.

The detection procedure is repeated by appending a new sequence of k=1 measurements (the last) {Xₙ₊₁} stated otherwise a new break is sought in the series { Xᵣ, . . . Xₙ, Xₙ₊₁} of 7 measurements.

| | break point | | | | | | | | | | | |
|---|---|---|---|---|---|---|---|---|---|---|---|---|
| | N ≧ r > 1 | 1 | 2 | 3 | 4 | 5 | 6 | 7 | 8 | 9 | 10 | 11 |
| | Series of | | | | | 0.415 | 1.035 | 1.104 | 0.939 | 1.293 | 0.85 | 0.89 |
| | measurements | | | | | | | | | | | |
| μ₀ | 0.93228571 | | | | | | | | | | | |
| nobs | 7 | | | | | | | | | | | |
| μ₁ | | | | | | 0.415 | 0.725 | 0.85133333 | 0.87325 | 0.9572 | 0.93933333 | |
| n₁ | | | | | | 1 | 2 | 3 | 4 | 5 | 6 | |
| μ₂ | | | | | | 1.0185 | 1.0152 | 0.993 | 1.011 | 0.87 | 0.89 | |
| n₂ | | | | | | 6 | 5 | 4 | 3 | 2 | 1 | |
| LPRV | | | | | | 0.06756342 | 0.04339597 | 0.01489198 | 0.01407992 | 0.000391821 | 0.00045148 | |
| (! μ₁ − μ₂!/ | | | | | | 1.05049315 | | | | | | |
| σ · (1/n₁ + | | | | | | | | | | | | |
| 1/n₂)\hat{ }0.5) | | | | | | | | | | | | |

| | |
|---|---|
| BREAK? 1/0 | 0 |

The potential break point r is determined at r=6, with a maximum value of the weighted likelihood ratio LPRV=0.0675.

The test value

$$T = \vert \frac{{μ}_{1} - {μ}_{2}}{σ \times \sqrt{\frac{1}{r - 1} + \frac{1}{n - ( r - 1 )}}} \vert$$

is then 1.0504, the assumption of equality of the means (absence of break) Hᵤₙ is then accepted (T<U⁻¹(1−α/2)=3).

The mean of the plateau is then Hₒ=0.932 and the smoothing is terminated.

The observations Xᵢ and the plateaus obtained are represented in the graph of FIG. 3.

The graph of FIG. 4 illustrates another example of characteristics of a weld bead in which a smoothing by break has been performed on a series of 123 measurements Xᵢ of profilometry of the bead. The measurements of the characteristics and the smoothing by plateaus are represented.

The graph of FIG. 5 illustrates yet another example of calculations for detecting breaks in a simulation of 85 Gaussian measurements with real standard deviation σ=0.5 for which the true means of the plateaus were naturally known. The similarity of the estimated plateaus and of the true plateaus will be noted.

The break detection, such as described above, is carried out on pyrometric and profilometric signals which correspond to the welded bead. More particularly, it is preferable to eliminate all the data which is not representative of the bead, that is to say all the data taken into account before or after the bead is welded. In practice and for serial use, this elimination phase is unnecessary. Indeed, the pyrometry and profilometry signals are recorded only during the welding phase.

Subsequent to the smoothing by break, the pyrometric or profilometric signal is compressed to extract explanatory variables {X_{1%}, X_{5%}, . . . , X_{95%}, X_{99%}} of a logistic discrimination model.

Consider the window of n observations {_X₁, . . . , _Xₙ} assumed Gaussian corresponding to the mean values of the plateaus of the pyrometric or profilometric signals smoothed previously by detecting breaks of the measurements {X₁, . . . , Xₙ} as illustrated by the curve in plateaus of FIG. 4:

To compress the signal smoothed by way of breaks {_X₁, . . . , _Xₙ}

1. we construct an empirical distribution function CdFE of the data smoothed by way of breaks {_X₁, . . . , _Xₙ}:
1.1. we sort the n observations {_X₁, . . . , _Xₙ} in ascending order,
1.2. we calculate

$$CdFE ( {\_X}_{i} ) = {p}_{i} = \frac{( i - 0.3 )}{( n + 0.4 )}$$

where i is the rank of the observation _Xᵢ after sorting.

2. we extract the quantiles {X_{1%}, X_{5%}, X_{10%}, X_{15%}, . . . , X_{95%}, X_{99%}} of probability p=1%, 5%, . . . , 99% by linear interpolation between the quantiles [X_{p-%},X_{p+%}] of probability p⁻% and p⁺% of the empirical distribution function at the p% level.

Example: For the threshold p=70%, the abscissa points [X_{p-%}, X_{p+%}]=[X_{69.45%}, X_{70.26%}]=[−0.19075, −0.10694] are adopted at the ordinates [p⁻%, p⁺%]=[69.45%, 70.26%] on the basis of which the quantile X_{70%}=−0.1204 is estimated by linear interpolation, as illustrated by FIG. 6.

The extraction of the quantiles {X_{1%}, X_{5%}, X_{10%}, X_{15%}, . . . , X_{95%}, X_{99%}} on the basis of the CdFE is therefore carried out as described previously and illustrated in FIG. 7. Stated otherwise, a “compression” of the empirical distribution function CdFE is carried out.

In a following step, a logistic model for discriminating the welds is defined.

Accordingly, the logistic model is of the logistic regression type. Logistic regression is a statistical technique the objective of which is, on the basis of a file of n observations, to produce a model making it possible to predict the values taken by a (usually) binary categorical variable Y, on the basis of the series of continuous explanatory variables {X₁, X₂, . . . , Xₚ}.

Logistic regression is used in technical sectors very remote from that of the invention:
in the banking sector, to detect groups at risk when allotting credit;
in econometrics, to explain voting intentions at elections;
in medicine, to establish a diagnosis on the basis of the criteria obtained on medical analyses when the latter make it possible to discriminate ill subjects with respect to healthy subjects.

With respect to the techniques that are known in regression, in particular linear regression, logistic regression is essentially distinguished by the fact that the explained variable Y is categorical. As a prediction scheme, logistic regression is comparable to discriminant analysis.

The goal is to predict with the aid of 21 quantitative variables {X_{1%}, X_{5%}, X_{10%}, X_{15%}, . . . , X_{95%}, X_{99%}} arising from the compression of the pyrometric and profilometric signals of the bead:
a) the probability of a yes (1: the bead is non-compliant) or of a no (0: the bead is perhaps compliant) for the response Y_{NC/C} in relation to tensile mechanical strength, and
b) the probability of a yes (1: the bead is uncertain) or of a no (0: the bead is compliant) for the response Y_{I/C} in relation to tensile mechanical strength.

This corresponds to modeling the binary response variable Y (1 the bead is non-compliant/0 the bead is compliant) as a function of 21 variables {X_{1%}, X_{5%}, X_{10%}, X_{15%}, . . . , X_{95%}, X_{99%}} and of a constant term i.e. a model with p+1=22 parameters βᵢ:

Yᵢ=βₒ+β₁.X_{1%}β₂.X_{5%}+ . . . +β₂₁.X_{99%}+εᵢ Yᵢ=0 or 1, for i=1, . . . , n and εᵢ=N(0, σ²)

The logistic modeling gives good results. The explanatory variables {X_{1%}, X_{5%}, X_{10%}, X_{15%}, . . . , X_{95%}, X_{99%}} are likened here to values representing of the order 5% of the length of the bead.

The logistic model comprises, for example, two logistic sub-models {Y_{NC/C}, Y_{I/C}}. The logistic model can also comprise fewer than two logistic sub-models or more than two logistic sub-models.

This logistic model is then applied to the signals characteristic of the bead, which are compressed by the previous scheme defined hereinabove: pyrometry signals or profilometry signals.

The decision rule pertaining to the compliance or non-compliance of the bead was described previously and is illustrated by the flowchart of FIG. 8.

Logistic regression differs fundamentally from conventional linear regression. In the conventional linear regression model:

Yᵢ=Xᵢ.B+εᵢ Yᵢ=0 or 1, for i=1, . . . ,n εᵢ=N(0,σ²)
since E(εᵢ)=0, then E(Yᵢ)=Xᵢ.β with E the mathematical expectation.

When the response Yᵢ is binary and follows a Bernouilli law B(p), we also have:

P(Yᵢ=1)=pᵢ and P(Yᵢ=0)=1−pᵢ with pᵢ ∈[0,1]

Therefore, E(Yᵢ)=1×pᵢ+0×(1−pᵢ)=pᵢ thus E(Yᵢ)=Xᵢ.β=pᵢ

With the linear modeling for a yes/no response, we are confronted with the problem that E(Yᵢ)=Xᵢ.β is not constrained to take values between 0 and 1, whereas pᵢ represents a probability which must take values in the interval [0,1]. Knowing that when a binary response variable Y is modeled, the form of the relation is often nonlinear; we advocate the nonlinear function of logistic type since it gives good results and is numerically simple to manipulate.

In fact and just as for the linear regression, the logistic regression model is defined by:

P(Yᵢ=1 |Xᵢ)=P(Yᵢ>0)=P(Xᵢ.β>−εᵢ)=F(Xᵢβ)

where F is the logistic distribution function of −εᵢ

$$\{ \begin{matrix} P ( Y = 1 \text{/} X = {X}_{i} ) = π ( {x}_{i} ) = F ( {X}_{i} \cdot β ) = \frac{{e}^{{X}_{i} \cdot β}}{1 + {e}^{{X}_{i} \cdot β}} = \frac{1}{1 + {e}^{- {X}_{i} \cdot β}} \\ P ( Y = 0 \text{/} X = {X}_{i} ) = 1 - π ( {x}_{i} ) = \frac{1}{1 + {e}^{- {X}_{i} \cdot β}}\end{matrix}$$

It will be noted that Y=1 if e^{-X}^{ᵢ}^{.β} is quasi-zero i.e. if Xβ is strongly positive (>10), and that Y=0 if e^{X}^{ᵢ}^{.β} is quasi-zero i.e. if Xβ is strongly negative (<−10).

To use the model for purposes of describing the relation or of prediction (rating Y of a new bead on the basis of the measurements X), we need to estimate the parameters β of the model. To do this, it is possible to use the maximum likelihood scheme, detailed hereinafter (that is to say the maximum probability scheme) to estimate the vector β. (In a parallel manner, for a linear regression, the least squares scheme is typically used).

$$V ( β ) = {Π}_{i = 1 , n} P ( {Y}_{i} = {y}_{i} \vert {X}_{i} = {x}_{i} ) = Π P ( {Y}_{i} = 1 \vert {X}_{i} = {x}_{i} ) \cdot Π P ( {Y}_{i} = 0 \vert {X}_{i} = {x}_{i} )$$

$$with$$

$$\{ \begin{matrix}P ( Y = 1 / X = {X}_{i} ) = π ( {x}_{i} ) = \frac{1}{1 + {e}^{- {X}_{i} \cdot β}} \\ P ( Y = 0 / X = {X}_{i} ) = 1 - π ( {x}_{i} ) = \frac{1}{1 + {e}^{{X}_{i} \cdot β}}\end{matrix}$$

The Log-likelihood may be written:

f(\vec{β})=ln(V(\vec{β}))=Σᵢ−ln(1+exp(−Xβ))_{(Yi=1)}−ln(1+exp(Xβ))_{Yi=0)}

The maximum is obtained by setting the partial derivatives to zero:

d(ln(V(β)))/dβ=0

The estimators β are obtained by a numerical procedure (gradient-based optimization) since there is no analytic expression.

Gradient scheme based on Taylor expansion

$$f ( \vec{β} ) = f ( \vec{{β}_{o}} ) + ( \vec{β} - \vec{{β}_{o}} ) \cdot {f}^{′} ( \vec{{β}_{o}} ) + \frac{( \vec{β} - \vec{{β}_{o}} )}{2} \cdot {f}^{″} ( \vec{{β}_{o}} ) + … {f}^{′} ( \vec{β} ) = 0 \to \vec{β} = \vec{{β}_{o}} - \frac{{f}^{′} ( \vec{{β}_{o}} )}{{f}^{″} ( \vec{{β}_{o}} )} = \vec{{β}_{o}} - {H}^{- 1} \times G ( \vec{{β}_{o}} )$$

the solution is a maximum if f″(\vec{βₒ})<0

H: Hessian matrix H_{(p,p)} if \vec{β} comprises p parameters to be estimated

$${H}_{i , j} = {lim}_{{h}_{i} , {h}_{j} \to 0} \frac{{δ}^{2} f}{δ {β}_{i} {β}_{j}} = \frac{f ( \vec{β + {h}_{i} \cdot {e}_{i} + {h}_{j} \cdot {e}_{j}} ) - f ( \vec{β + {h}_{i} \cdot {e}_{i}} ) - f ( \vec{β + {h}_{j} \cdot {e}_{j}} ) + f ( \vec{β} )}{{h}_{i} \cdot {h}_{j}}$$

G: gradient vector

$${G}_{i} = {lim}_{{h}_{i} \to 0} \frac{δ f}{{δβ}_{i}} = \frac{f ( \vec{β + {h}_{i} \cdot {e}_{i}} ) - f ( \vec{β} )}{{h}_{i}} {h}_{i} = 0.001$$

This is a scheme of complexity p² since it requires for the p parameters βᵢ at each iteration
a calculation of the function f(\vec{β})=ln(V(\vec{β}))
p calculations of the function f(\vec{β+hᵢ.eᵢ}) estimate the derivatives

$${G}_{i} = {lim}_{{h}_{i} \to 0} \frac{δ f}{δ {β}_{i}} = \frac{f ( \vec{β + {h}_{i} \cdot {e}_{i}} ) - f ( \vec{β} )}{{h}_{i}}$$

p(p+1)/2 calculations of the function f(\vec{β+hᵢ.eᵢ+hⱼ.eⱼ}) to estimate the second derivatives:

$${H}_{i , j} = {lim}_{{h}_{i} , {h}_{j} \to 0} \frac{{δ}^{2} f}{δ {β}_{i} {β}_{j}}$$

In the case of an exemplary logistic sub-model of the type

$${Y}_{NC / C} = \frac{1}{1 + exp - ( {β}_{o} + {β}_{1} \cdot X 1 + {β}_{2} \cdot X 2 )}$$

with k=2 continuous explanatory variables X1, X2 and p=k+1 parameters

Consider n=10 observations, for which two continuous explanatory variables X1, X2 and the binary response Y_{NC/C} are available, and two complementary observations for which we seek to predict the response Y_{NC/C}, as indicated in the table hereinbelow and represented in FIG. 9:

| X1 | X2 | Y_{NC/C} |
|---|---|---|
| 0.345 | −0.273 | 1 |
| 0.415 | −0.199 | 1 |
| 0.301 | −0.095 | 1 |
| 0.303 | −0.042 | 1 |
| −0.295 | 0.006 | 0 |
| −0.273 | 0.097 | 0 |
| −0.186 | 0.072 | 0 |
| −0.074 | 0.039 | 0 |
| −0.129 | −0.172 | 0 |
| −0.206 | 0.109 | 0 |
| 0.173 | −0.1 | ? |
| −0.34 | 0.164 | ? |

To construct the logistic regression model

$${Y}_{NC / C} = \frac{1}{1 + exp - ( {β}_{o} + {β}_{1} \cdot X 1 + {β}_{2} \cdot X 2 )}$$

the following steps are performed:

In a first step, we check whether the matrix of the explanatory variables X=[1, X1, X2] is of full rank. To do this, a multiple linear regression Y=βo+β1.X1+β2.X2+ε is performed. The vector of the p=3 parameters β is given by the analytic formula: β=(X′X)⁻¹.X′Y.

The matrix X of dimension (n=10, p=3) is:

| Cst | X1 | X2 |
|---|---|---|
| 1 | 0.345 | −0.273 |
| 1 | 0.415 | −0.199 |
| 1 | 0.301 | −0.095 |
| 1 | 0.303 | −0.042 |
| 1 | −0.295 | 0.006 |
| 1 | −0.273 | 0.097 |
| 1 | −0.186 | 0.072 |
| 1 | −0.074 | 0.039 |
| 1 | −0.129 | −0.172 |
| 1 | −0.206 | 0.109 |

The solution is:

| | Cst | X1 | X2 |
|---|---|---|---|
| β = (X′X)⁻¹.X′Y | 0.375277202 | 1.85247037 | 0.273184635 |

If the matrix X′X is not invertible, it is because one or more explanatory variables X1, X2 are linear combinations of the other variables. New measurements [X1, X2, Y_{NC/C}] are then collected until the linear regression allows the parameters to be estimated.

In a second step, a first iteration of the logistic model

$${Y}_{NC / C} = \frac{1}{1 + exp - ( {β}_{o} + {β}_{1} \cdot X 1 + {β}_{2} \cdot X 2 )}$$

is performed.

Consider the n=10 observations of the training sample, the procedure for maximizing the Log-likelihood f(\vec{β})=ln(V(\vec{β})) is initialized with the solution \vec{β}=\vec{0}. The function f(\vec{β})=ln(V(\vec{0}))=n.ln(0,5)=−n.ln(2) since for any observation P(Y=1|X=Xᵢ)=P(Y=0|X=Xᵢ)=0.5.

At convergence ||G(\vec{β})||=0 and the optimum of the likelihood function f(\vec{β})=ln(V(\vec{β}))→0 .

The initial vector \vec{β}=\vec{0} of parameters is:
Logistic model Y=1/(1+exp(−(βₒ+β₁.X1+βₓ.X2))):
Initialization

Par. β

| Cst | X1 | X2 | ln(V(β)) |
|---|---|---|---|
| 0 | 0 | 0 | −6.931471806 |

The solution f(β)=ln(Likelihood)=ln(V(β))=−n.Ln(2)=−10.ln(2)=−6.93147
The p=3 vectors \vec{β}=\vec{β+hᵢ.eᵢ} of parameters of the Gradient (first derivatives) are estimated with hᵢ=0.001.
The p(p+1)/2=6 vectors \vec{β}=\vec{β+hᵢ.eᵢ+hⱼ.eⱼ} of parameters of the Hessian matrix (second derivatives) are estimated with hᵢ=hⱼ=0.001.

| | | |
|---|---|---|
| Cst | X1 | X2 |

Par. β

| | | |
|---|---|---|
| 0 | 0 | 0 |

Par. (β + hᵢ.eᵢ) of the Gradient

| | | | |
|---|---|---|---|
| Cst | 0.001 | 0 | 0 |
| X1 | 0 | 0.001 | 0 |
| X2 | 0 | 0 | 0.001 |

Par. (β + hᵢ.eᵢ + hⱼ.eⱼ) of the Hessian

| | | | | |
|---|---|---|---|---|
| Cst | Cst | 0.002 | 0 | 0 |
| Cst | X1 | 0.001 | 0.001 | 0 |
| Cst | X2 | 0.001 | 0 | 0.001 |
| X1 | X1 | 0 | 0.002 | 0 |
| X1 | X2 | 0 | 0.001 | 0.001 |
| X2 | X2 | 0 | 0 | 0.002 |

The function f(β)=Σᵢ ln(P(Y=Yᵢ)), the components of the gradient G(β) and of the Hessian H(β) are estimated in regard to the previous coefficient vectors, on the basis of the explanatory variables X1, X2 according to the value 1/0 of the response Y_{NC/C}.

| | | | | Estimation of | | | | |
|---|---|---|---|---|---|---|---|---|
| | | | | the function | | | | |
| | | | | f(β) | Rank- | Estimation of the components of the gradient f(β + hi · ei) | | |
| Cst | X1 | X2 | Y_{NC/C} | f(β) | ing | f(β + h₀ · e₀) | f(β + h₁ · e₁) | f(β + h₂ · e₂) |
| 1 | 0.345 | −0.273 | 1 | −0.693147181 | 1 | −0.692647306 | −0.692974695 | −0.69328369 |
| 1 | 0.415 | −0.199 | 1 | −0.693147181 | 1 | −0.692647306 | −0.692939702 | −0.693246686 |
| 1 | 0.301 | −0.095 | 1 | −0.693147181 | 1 | −0.692647306 | −0.692996692 | −0.693194682 |
| 1 | 0.303 | −0.042 | 1 | −0.693147181 | 1 | −0.692647306 | −0.692995692 | −0.693168181 |
| 1 | −0.295 | 0.006 | 0 | −0.693147181 | 1 | −0.693647306 | −0.692999691 | −0.693150181 |
| 1 | −0.273 | 0.097 | 0 | −0.693147181 | 1 | −0.693647306 | −0.69301069 | −0.693195682 |
| 1 | −0.186 | 0.072 | 0 | −0.693147181 | 1 | −0.693647306 | −0.693054185 | −0.693183181 |
| 1 | −0.074 | 0.039 | 0 | −0.693147181 | 1 | −0.693647306 | −0.693110181 | −0.693166681 |
| 1 | −0.129 | −0.172 | 0 | −0.693147181 | 1 | −0.693647306 | −0.693082683 | −0.693061184 |
| 1 | −0.206 | 0.109 | 0 | −0.693147181 | 1 | −0.693647306 | −0.693044186 | −0.693201682 |
| 1 | 0.173 | 0.i | | | 1 | | | |
| 1 | −0.34 | 0.164 | | | 1 | | | |

| In(V(β)) | In(V(β + h₀ · e₀)) | In(V(β + h₁ · e₁)) | In(V(β + h₂ · e₂)) |
|---|---|---|---|
| −6.931471806 | −6.932473056 | −6.930208397 | −6.931851828 |

Estimation of the components of the Hessian f(β + hᵢ.eᵢ + hⱼ.eⱼ)

| Cst | Cst | Cst | X1 | X1 | X2 |
|---|---|---|---|---|---|
| Cst | X1 | X2 | X1 | X2 | X2 |
| −0.692147681 | −0.692474907 | −0.692783747 | −0.69280224 | −0.693111181 | −0.693420218 |
| −0.692147681 | −0.692439931 | −0.692746761 | −0.692732267 | −0.693039186 | −0.6933462 |
| −0.692147681 | −0.692496892 | −0.692694783 | −0.692846226 | −0.693044186 | −0.693242185 |
| −0.692147681 | −0.692495893 | −0.692668295 | −0.692844226 | −0.693016689 | −0.693189181 |
| −0.694147681 | −0.693499743 | −0.693650307 | −0.692852224 | −0.693002691 | −0.693153181 |
| −0.694147681 | −0.693510747 | −0.693695831 | −0.692874218 | −0.693059184 | −0.693244185 |
| −0.694147681 | −0.693554263 | −0.693683324 | −0.692961198 | −0.693090182 | −0.693219183 |
| −0.694147681 | −0.693610288 | −0.693666816 | −0.693073183 | −0.693129681 | −0.693186181 |
| −0.694147681 | −0.693582775 | −0.693561266 | −0.693018189 | −0.692996692 | −0.692975195 |
| −0.694147681 | −0.693544259 | −0.693701834 | −0.692941202 | −0.693098682 | −0.693256187 |

ln(V(β + hᵢ.eᵢ + ln(V(β + hᵢ.eᵢ + hⱼ.eⱼ))ln(V(β + hᵢ.eᵢ + hⱼ.eⱼ)) ln(V(β + hᵢ.eᵢ + hⱼ.eⱼ)) ln(V(β + hᵢ.eᵢ + hⱼ.eⱼ))ln(V(β + hᵢ.eᵢ + hⱼ.eⱼ)) hⱼ.eⱼ))

| | | | | | |
|---|---|---|---|---|---|
| −6.933476806 | −6.931209698 | −6.932852964 | −6.928945173 | −6.930588354 | −6.932231897 |

The components of the Gradient vector G(β) are calculated for the 3 parameters by:

$${G}_{i} = {lim}_{{h}_{i} \to 0} \frac{δ f}{δ {β}_{i}} = \frac{f ( \vec{β + {h}_{i} \cdot {e}_{i}} ) - f ( \vec{β} )}{{h}_{i}} {h}_{i} = 0.001 ;$$

convergence (and therefore maximization of the likelihood) is achieved if the norm of the vector G(β) is zero or less than 10⁻⁶ or if the determinant of the Hessian matrix is quasi-zero (|D|<10⁻¹⁸⁰3.

| Par. β | Cst | X1 | X2 | In(V(β)) |
|---|---|---|---|---|
| | 0 | 0 | 0 | −6.931471806 |

| Par. (β + hᵢ · eᵢ) | | | | | |
|---|---|---|---|---|---|
| of the Gradient | Cst | X1 | X2 | G(β) | norm G(β) |
| Cst | 0.001 | 0 | 0 | −1.00125 | 1.656236455 |
| X1 | 0 | 0.001 | 0 | 1.263408205 | |
| X2 | 0 | 0 | 0.001 | −0.380022817 | |

At the first iteration, the gradient G(β) has norm: 1.6562.

The symmetric square matrix of dimension (p,p) with Hessian H(β) is calculated by:

$${H}_{i , j} = {lim}_{{h}_{i} , {h}_{j} \to 0} \frac{{δ}^{2} f}{δ {β}_{i} {β}_{j}} = \frac{f ( \vec{β + {h}_{i} \cdot {e}_{i} + {h}_{j} \cdot {e}_{j}} ) - f ( \vec{β + {h}_{i} \cdot {e}_{i}} ) - f ( \vec{β + {h}_{j} \cdot {e}_{j}} ) + f ( \vec{β} )}{{h}_{i} \cdot {h}_{j}}$$

| | Hessian Matrix | | | | | Matrix inverse of the Hessian | | | |
|---|---|---|---|---|---|---|---|---|---|
| | Cst | X1 | X2 | Det of H | | Cst | X1 | X2 | H⁻¹ · G |
| Cst | −2.499999 | −0.05025 | 0.1145 | −0.008381 | Cst | −0.484285 | −0.624306 | −2.114256 | 0.4996022 |
| X1 | −0.05025 | −0.183591 | 0.0657215 | | X1 | −0.624306 | −12.04854 | −18.9188 | −7.407563 |
| X2 | 0.1145 | 0.0657215 | −0.045633 | | X2 | −2.114256 | −18.9188 | −54.46557 | −1.087116 |

It is invertible (|Det(H)|<10⁻¹⁸⁰)so we estimate the terms H⁻¹.G on the basis of which we calculate the new vector of parameters β=β−H⁻¹.G.

| Final Pars. β | | | |
|---|---|---|---|
| b = β − H⁻¹ · G | Cst | X1 | X2 |
| | −0.499602169 | 7.407563379 | 1.087115869 |

In a third step, a second iteration of the logistic model is performed.

$${Y}_{NC / C} = \frac{1}{1 + exp - ( {β}_{o} + {β}_{1} \cdot X 1 + {β}_{2} \cdot X 2 )}$$

We start from the previous solution (table hereinabove) with which we estimate the function f(β)=ln(Likelihood)=ln(V(β))=−1.5288

Logistic model Y = 1/(1 + exp(−(β₀ +
β₁.X1 + β₂.X2))): Iteration 2
Par. β

| Cst | X1 | X2 | ln(V(β)) |
|---|---|---|---|
| −0.499602169 | 7.407563379 | 1.087115869 | −1.52883595 |

The likelihood f(β) is greater than the previous estimation (ln(V(β))=−n.ln(2)=−6.93147).

As previously:
the p=3 vectors \vec{β}=\vec{β+hᵢ.eᵢ} of the parameters of the Gradient (first derivatives) are estimated with hᵢ=0.001;
the p(p+1)/2=6 vectors \vec{β}=\vec{β+hᵢ.eᵢ+hⱼ.eⱼ} of the parameters of the Hessian matrix (second derivatives) are estimated with hᵢ=hⱼ=0.001.

Logistic Model Y = 1/(1 + exp(−(β₀ +
β₁.X1 + β₂.x2))): Iteration 2

| | | |
|---|---|---|
| Cst | X1 | X2 |

Par. β

| | | |
|---|---|---|
| −0.499602169 | 7.407563379 | 1.087115869 |

Par. (β + hᵢ.eᵢ) of the Gradient

| | | | |
|---|---|---|---|
| Cst | −0.498602169 | 7.407563379 | 1.087115869 |
| X1 | −0.499602169 | 7.408563379 | 1.087115869 |
| X2 | −0.499602169 | 7.407563379 | 1.088115869 |

Par. (β + hᵢ.eᵢ + hⱼ.eⱼ) of the Hessi#Z.899;

| | | | | |
|---|---|---|---|---|
| Cst | Cst | −0.497602169 | 7.407563379 | 1.087115869 |
| Cst | X1 | −0.498602169 | 7.408563379 | 1.087115869 |
| Cst | X2 | −0.498602169 | 7.407563379 | 1.088115869 |
| X1 | X1 | −0.499602169 | 7.409563379 | 1.087115869 |
| X1 | X2 | −0.499602169 | 7.408563379 | 1.088115869 |
| X2 | X2 | −0.499602169 | 7.407563379 | 1.089115869 |

The function f(β)=Σᵢ ln(P(Y=Yᵢ)), the components of the gradient G(β) and of the Hessian H(β) are estimated on the basis of the data according to the value 1/0 of the response Y_{NC/C} as a function of the previous coefficient vectors.

| | | | | | | Estimation of the components of | | |
|---|---|---|---|---|---|---|---|---|
| | | | | Estimation of the function | | the gradient f(β + hi · ei) | | |
| Cst | X1 | X2 | YNC/ C | f(β) | Ranking | f (β + h₀ · e₀) | f (β + h₁ · e₁) | f (β + h₂ · e₂) |
| 1 | 0.345 | −0.273 | 1 | −0.158864 | 1 | −0,158717 | −0.158813 | −0.158904 |
| 1 | 0.415 | −0.199 | 1 | −0.09038 | 1 | −0.090294 | −0.090344 | −0.090397 |
| 1 | 0.301 | −0.095 | 1 | −0.179449 | 1 | −0.179285 | −0.1794 | −0.179465 |
| 1 | 0.303 | −0.042 | 1 | −0.167905 | 1 | −0.16775 | −0.167858 | −0.167911 |
| 1 | −0.295 | 0.006 | 0 | −0.066423 | 0 | −0.066488 | −0.066404 | −0.066424 |
| 1 | −0.273 | 0.097 | 0 | −0.085481 | 0 | −0.085563 | −0.085459 | −0.085489 |
| 1 | −0.186 | 0.072 | 0 | −0.1531 | 0 | −0.153242 | −0.153074 | −0.15311 |
| 1 | −0.074 | 0.039 | 0 | −0.311822 | 0 | −0.31209 | −0.311802 | −0.311832 |
| 1 | −0.129 | −0.172 | 0 | −0.176941 | 0 | −0.177104 | −0.17692 | −0.176914 |
| 1 | −0.206 | 0.109 | 0 | −0.13847 | 0 | −0.1386 | −0.138444 | −0.138485 |
| 1 | 0.173 | −0.1 | | | 1 | | | |
| 1 | −0.34 | 0.164 | | | 0 | | | |

| | | | | In(V(β)) | In(V(β + h [symbol] | In(V(β + h₁ [symbol] | In(V(β + h₂ · e₂) |
|---|---|---|---|---|---|---|---|
| 1 | 7.4075634 | 1. 0871159 | 0 | −1.528836 | −1.529132 | −1.528518 | −1.528931 |

Estimation of the components of the Hessian f(β + h₁ · e₁ + h₁ · e₁)

| Cst | Cst | Cst | X1 | X1 | X2 |
|---|---|---|---|---|---|
| Cst | X1 | X2 | X1 | X2 | X2 |
| −0.15857 | −0.158666 | −0.158757 | −0.158763 | −0.158853 | −0.158944 |
| −0.090207 | −0.090258 | −0.090311 | −0.090308 | −0.090361 | −0.090415 |
| −0.179121 | −0.179235 | −0.1793 | −0.17935 | −0.179415 | −0.17948 |
| −0.167596 | −0.167704 | −0.167757 | −0.167811 | −0.167865 | −0.167918 |
| −0.066552 | −0.066469 | −0.066488 | −0.066385 | −0.066405 | −0.066424 |
| −0.085645 | −0.085541 | −0.085571 | −0.085436 | −0.085467 | −0.085497 |
| −0.153384 | −0.153216 | −0.153252 | −0.153047 | −0.153084 | −0.153121 |
| −0.312358 | −0.31207 | −0.3121 | −0.311782 | −0.311812 | −0.311843 |
| −0.177266 | −0.177083 | −0.177076 | −0.1769 | −0.176893 | −0.176886 |
| −0.138729 | −0.138573 | −0.138614 | −0.138417 | −0.138458 | −0.138499 |

| | | | | | In(V(β + h₁ · e₁ + |
|---|---|---|---|---|---|
| In(V(β + h [symbol] | In(V(β + h [symbol] | In(V(β + h [symbol] | In(V(β + h [symbol] | In(V(β + h [symbol] | h₁ · e₁)) |
| −1.529429 | −1.528814 | −1.529226 | −1.5282 | −1.528613 | −1.529025 |

[symbol]

indicates data missing or illegible when filed

The components of the Gradient vector G(β) are calculated for the 3 parameters by:

$${G}_{i} = {lim}_{{h}_{i} \to 0} \frac{δ f}{δ {β}_{i}} = \frac{f ( \vec{β + {h}_{i} \cdot {e}_{i}} ) - f ( \vec{β} )}{{h}_{i}} {h}_{i} = 0.001 ,$$

convergence (and therefore maximization of the likelihood) is achieved if the norm of the vector G(β) is zero or less than 10⁻⁵.

Logistic model Y = 1/(1 + exp(−(β₀ +
β₁.X1 + β₂.X2))): Iteration 2
Par. β

| Cst | X1 | X2 | ln(V(β)) |
|---|---|---|---|
| −0.499602 | 7.4075634 | 1.0871159 | −1.528836 |

Par. (β + hᵢ.eᵢ) of the Gradient

| | Cst | X1 | X2 | G(β) | norm G(β) |
|---|---|---|---|---|---|
| Cst | −0.498602 | 7.4075634 | 1.0871159 | −0.295969 | 0.444525 |
| X1 | −0.499602 | 7.4085634 | 1.0871159 | 0.3178901 | |
| X2 | −0.499602 | 7.4075634 | 1.0881159 | −0.094608 | |

At the second iteration, the gradient has norm: 0.44452.

The symmetric square matrix of dimension (p,p) with Hessian H(β) is calculated by:

$${H}_{i , j} = {lim}_{{h}_{i} , {h}_{j} \to 0} \frac{{δ}^{2} f}{δ {β}_{i} {β}_{j}} = \frac{f ( \vec{β + {h}_{i} \cdot {e}_{i} + {h}_{j} \cdot {e}_{j}} ) - f ( \vec{β + {h}_{i} \cdot {e}_{i}} ) - f ( \vec{β + {h}_{j} \cdot {e}_{j}} ) + f ( \vec{β} )}{{h}_{i} \cdot {h}_{j}}$$

| | Hesian Matrix | | | | | Inverse matrix of the Hessian | | | |
|---|---|---|---|---|---|---|---|---|---|
| | Cst | X1 | X2 | Det of H | | Cst | X1 | X2 | H⁻¹ · G |
| Cst | −1.174095 | −0.040640558 | 0.055446252 | −0.000824677 | Cst | −1.000025146 | −0.831971866 | −3.75023476 | 0.38630187 |
| X1 | −0.040641 | −0.076095882 | 0.027718588 | | X1 | −0.831971866 | −26.07642953 | −36.73061205 | −4.568204597 |
| X2 | 0.0554463 | 0.027718588 | −0.020934351 | | X2 | −3.75023476 | −36.73061205 | −106.3351403 | −0.506229411 |

If it is invertible (|Det(H) |<10⁻¹⁸⁰), then we estimate the terms H⁻¹.G on the basis of which we calculate the new vector of parameters β=β−H⁻¹.G.

Final Pars. β b = β − H⁻¹.G

| Cst | X1 | X2 |
|---|---|---|
| −0.885904 | 11.975768 | 1.5933453 |

New iterations of the logistic model are performed, until convergence (at iteration 17 in the example).

Logistic Model Y = 1/(1 + exp(−(β₀ + β₁ · X1 + β₂ · X2))): Iteration 3

| Par. β | Cst | X1 | X2 | In(V(β)) |
|---|---|---|---|---|
| | −0.885904039 | 11.97576798 | 1.59334528 | [symbol] |

| Par · (β + h₁ · e₁) | | | | | |
|---|---|---|---|---|---|
| of the Gradient | Cst | X1 | X2 | G(β) | norm G(β) |
| Cst | −0.884904039 | 11.97576798 | 1.59334528 | −0.118516471 | 0.168549145 |
| X1 | −0.885904039 | 11.97676798 | 1.59334528 | 0.114846207 | |
| X2 | −0.885904039 | 11.97576798 | 1.59434528 | −0.034249219 | |

| Par. (β + h₁ · e₁ + h₁ · e₁₎ of the Hessi [symbol] | | Cst | X1 | X2 |
|---|---|---|---|---|
| Cst | Cst | −0.883904039 | 11.97576798 | 1.59334528 |
| Cst | X1 | −0.884904039 | 11.97676798 | 1.59334528 |
| Cst | X2 | −0.884904039 | 11.97576798 | 1.59434528 |
| X1 | X1 | −0885904039 | 11.97776798 | 1.59334528 |
| X1 | X2 | −0.885904039 | 11.97676798 | 1.59434528 |
| X2 | X2 | −0.885904039 | 11.97576798 | 1.59534528 |

Logistic Model Y = 1/(1 + exp(−(β₀ + β₁ · X1 + β₂ · X2))): Iteration 17

| Par. β | Cst | X1 | X2 | In(V(β)) |
|---|---|---|---|---|
| | −8.148111892 | 76.18875899 | -0.622678219 | [symbol] |

| Par · (β + h₁ · e₁) | | | | | |
|---|---|---|---|---|---|
| of the Gradient | Cst | X1 | X2 | G(β) | norm G(β) |
| Cst | −8.147111892 | 76.18875899 | −0.622678219 | −3.37388E-07 | 4.4963E-07 |
| X1 | −8.148111892 | 76.18975899 | −0.622678219 | 2.84316E-07 | |
| X2 | −8,148111892 | 76.18875899 | −0,621678219 | −8.66089E-08 | |

| Par. (β + h₁ · e₁ + h₁ · e₁₎ of the Hessi [symbol] | | Cst | X1 | X2 |
|---|---|---|---|---|
| Cst | Cst | −8.146111892 | 76.18875899 | −0.622678219 |
| Cst | X1 | −8.147111892 | 76.18975899 | −0.622678219 |
| Cst | X2 | −8.147111892 | 76.18875899 | −0.621678219 |
| X1 | X1 | −8.148111892 | 76.19075899 | −0.622678219 |
| X1 | X2 | −8.148111892 | 76.18975899 | −0.621678219 |
| X2 | X2 | −8.148111892 | 76.18875899 | −0.620678219 |

[symbol]

indicates data missing or illegible when filed

The model found is then:

$${Y}_{NC / C} = \frac{1}{1 + exp - ( \begin{matrix}- 8.148111892 + 76.18875899 \cdot X 1 - \\ 0.622678219 \cdot X 2\end{matrix} )} ,$$

it is then possible to predict for an observation pair (X1, X2):
the response Y_{NC/C}=1 if

$$\frac{1}{1 + exp - ( \begin{matrix}- 8.148111892 + 76.18875899 \cdot X 1 - \\ 0.622678219 \cdot X 2\end{matrix} )} > 0.5$$

$$and the response 0 if$$

$$\frac{1}{1 + exp - ( \begin{matrix}- 8.148111892 + 76.18875899 \cdot X 1 - \\ 0.622678219 \cdot X 2\end{matrix} )} <= 0.5$$

Thus, it is possible to predict the response Y_{NC/C} relating to the last two observations, as indicated hereinbelow:

| X1 | X2 | Y_{NC/C} | X.β | pred Y_{NC/C} |
|---|---|---|---|---|
| 0.345 | −0.273 | 1 | 18.307 | 1 |
| 0.415 | −0.199 | 1 | 23.594 | 1 |
| 0.301 | −0.095 | 1 | 14.844 | 1 |
| 0.303 | −0.042 | 1 | 14.963 | 1 |
| −0.295 | 0.006 | 0 | −30.628 | 0 |
| −0.273 | 0.097 | 0 | −29.008 | 0 |
| −0.186 | 0.072 | 0 | −22.364 | 0 |
| −0.074 | 0.039 | 0 | −13.81 | 0 |
| −0.129 | −0.172 | 0 | −17.869 | 0 |
| −0.206 | 0.109 | 0 | −23.911 | 0 |
| 0.173 | −0.1 | | 5.095 | 1 |
| −0.34 | 0.164 | | −34.154 | 0 |

As seen previously, in the preamble of the first phase, weld trials are carried out.

These weld trials make it possible to train the model. These trials must be carried out in a structured manner, so that the trained model is representative of the parameters encountered during the serial phase.

It is possible, for example, to rely on an experimental design L9=3³. This type of experimental design is applicable when three or four factors vary: play between parts, power, speed.

In this example, nine trials are necessary for fine tuning the welding operation and constructing a welded beads training data sample (profilometry data and pyrometry data) by including the mechanical tests carried out on the trials, in particular tensile tests, to class or rate the quality of the weld trials as being “compliant”, “non-compliant” or “uncertain”.

Each trial of the experimental design can give rise to a minimum of k=5 training specimens so as to build a database from which the classing functions will be constructed, to which a validation specimen is added to test the a posteriori models.

It is ensured that the covariance matrix X′X for the profilometry and pyrometry data (compressed profiles {X_{1%}, X_{5%}, X_{10%}, X_{15%}, . . . , X_{95%}, X_{99%}} constructed from the distribution functions) is indeed of full rank before estimating the parameters β of the logistic models, if this is not the case then the already acquired data is supplemented, for example, with a second series of 9 trials (2^{nd} design L9).

On completion of the experimental design, the modeling by logistic regression is performed and is validated on the basis of the specimens (k+1) of each trial, the model is validated if no weld bead which is actually “non-compliant” is rated or predicted as being “compliant” by the logistic regression model.

The experimental design may be parameterized with the following parameters:
the choice (name) of the factors,
their possible values (−1, 0, 1) in user units (−1: mini, 0: (mini+maxi)/2, 1: maxi)
the type of welded join,
the mechanical strength compliance specification for the weld,
the number of specimens welded at each trial (k=5 at the minimum), plus the validation specimen.

A modification of a value of a criterion CdC of compliance of mechanical strength with the specification prompts a new calculation of the statistical criteria for rating the quality of the weld beads.

Two responses to the experimental design may be used:
The mean tensile strength response t̅ᵢ̅,
The tensile strength robustness response estimated by the Taguchi signal/noise ratio (SN ratio) SNᵢ.

$${s}_{i} = \sqrt{\frac{1}{n - 1} {\sum }_{j = 1}^{n} {( {t}_{i , j} - \overline{{t}_{i}} )}^{2}} \overline{{t}_{i}} = \frac{1}{n} {\sum }_{j = 1}^{n} {t}_{i , j} \to {SN}_{j} = 10 \times Log 10 ( {( \frac{\overline{{t}_{i}}}{{s}_{i}} )}^{2} )$$

The graphs of effects E of the factors for the two responses are represented as a function of the three possible values −1, 0, 1 of the factor.

E_{poss. value k}^{Factor i}= R̅e̅s̅p̅o̅n̅s̅e̅_̅{̅p̅o̅s̅s̅.̅ v̅a̅l̅u̅e̅ k̅}̅^̅{̅F̅a̅c̅t̅o̅r̅ i̅}̅− R̅e̅s̅p̅o̅n̅s̅e̅

It is possible to use a parabolic interpolation of the effects Eᵢ of each factor (3 possible values per factor) for the 3 possible values (−1, 0, 1) in the form:

E_{Fi}=a.(X+b)²+c

with

$$\{ \begin{matrix}a = \frac{3 \times ( {E}_{1}^{i} - {E}_{- 1}^{i} )}{2} & \\ b = \frac{( {E}_{1}^{i} - {E}_{- 1}^{i} )}{6 \times ( {E}_{i}^{i} + {E}_{- 1}^{i} )} & {E}_{k}^{i} = \overline{{X}_{k}^{i}} = \overline{\overline{{X}^{i}}} \\ c = {E}_{0}^{i} - \frac{( {E}_{1}^{i} - {E}_{- 1}^{i} )}{24 \times ( {E}_{i}^{i} + {E}_{- 1}^{i} )} & \end{matrix}$$

Examples of parabolic interpolations are represented in FIGS. 10 and 11.

Preferably, the solution maximizing the robustness (SN) is adopted by default as optimal solution (that is to say as optimal combination of the possible values of the factors). It is also possible to choose a solution which maximizes the mean response while minimizing the degradation of the robustness. The predictions of the responses SN and Mean are defined on the basis of the following equations:

$$\{ \begin{matrix}Mean = \overline{\overline{X}} + {\sum }_{i = 1}^{4} {E}_{{F}_{i}} ( {x}_{i} ) \\ SN = \overline{\overline{SN}} + {\sum }_{i = 1}^{4} {E}_{{F}_{i}} ( {x}_{i} )\end{matrix}$$

If a second series of trials has to be carried out, the two series of trials of the experimental design are analyzed as a whole to find the optimal setting.

Various types of experimental designs may be used. It is possible to for this purpose to consult the work “Pratique industrielle de la méthode Taguchi Les plans d'expériences” [Industrial practice with the Taguchi method Experimental designs] by Jacques Alexis, AFNOR.

The training base having been constructed, the 21 explanatory variables corresponding to the compressed profiles {X_{1%}, X_{5%}, X_{10%}, X_{15%}, . . . , X_{95%}, X_{99%}} and the quality rating (Compliant/Non-compliant/Uncertain) being available for each specimen k of each trial i; the 4 logistic sub-models may be constructed on the basis of the profilometric and/or pyrometric data.

The models are validated on the basis of the specimens (k+1) of each trial, the monitoring device is declared validated if no weld bead which is actually non-compliant is predicted by the model as being “compliant”. In the converse case, the procedure is repeated on the second series of trials and the 2×9 trials of the experimental design are analyzed as a whole to find the optimal setting.

In the above-mentioned second phase, the previously defined rating model is used, in particular used in real time during welding operations, for example on a mass production facility.

Thus, during welding or after welding, on the basis of the compressed profiles {X_{1%}, X_{5%}, X_{10%}, X_{15%}, . . . , X_{95%}, X_{99%}} of pyrometry and profilometry data, the quality of the weld is predicted according to the flowchart of FIG. 8:
the compliance of the bead,
the non-compliance of the bead, or
the “uncertain compliance” of the bead.

Preferably, if three consecutive beads are predicted “uncertain compliance” of the bead, then these three beads are considered to be non-compliant.

Preferably, it is possible to view the pyrometric and profilometric profiles smoothed by way of breaks, as well as the compressed profiles (the quantiles {X_{1%}, X_{5%}, X_{10%}, X_{15%}, . . . , X_{95%}, X_{99%}} constructed on the basis of the distribution functions) of the last 50 beads. It is also possible to save, in a database, compressed and time-stamped profiles and compliance predictions.

An embodiment of the first phase of a method for monitoring the quality of a weld according to invention is described hereinafter with reference to FIG. 12.

In a first step 10, specimens are produced during welding trials.

In a second step 20, data relating to these welding trials are acquired.

In a third step 30, a smoothing of the previously acquired data is carried out. This smoothing is for example carried out by way of breaks in mean.

In a fourth step 40, explanatory variables are extracted on the basis of the previously smoothed data.

In a step 60, carried out for example in parallel with steps 20 to 40, the quality of the weld trials is rated by verifying whether the specimens and therefore the welds, are compliant or non-compliant in regard to a criterion defined in a specification. This criterion may be a mechanical strength criterion and the rating can entail a mechanical strength trial, for example a tensile trial, carried out with the specimens.

In a step 50, the results of steps 40 and 60 are used to define parameters of the model of the rating of the quality of the welds. The parameters and the model are saved.

An embodiment of the second phase of a method for monitoring the quality of a weld according to invention is described hereinafter with reference to FIG. 13.

In a first step 110, a weld is produced.

In a second step 120, data relating to this weld are acquired.

In a third step 130, a smoothing of the previously acquired data is carried out. This smoothing is for example carried out by way of breaks in mean.

In a fourth step 140, explanatory variables are extracted on the basis of the previously smoothed data.

In a step 150, the results of step 140 and the model defined in step 50 are used.

Thus, in step 160, a rating of the quality of the weld is obtained.

An embodiment of a device for monitoring the quality of a weld according to invention is described hereinafter with reference to FIG. 14.

The monitoring device 1 mainly comprises a sensor 7 and a logic processing unit 8. The sensor may be of any nature. Preferably, it makes it possible to measure profilometric data and/or thermal data. It can in particular comprise a camera, such as a laser camera. The sensor is preferably a pyrometer. The data gathered by the sensor are transferred to the logic processing unit 8. This unit advantageously comprises a microcontroller and memories. It integrates the model defined on completion of step 50 of the first phase of the previously described monitoring method. Preferably, the processing unit comprises hardware and/or software means making it possible to govern the operation of the device for monitoring quality in accordance with the method according to invention, in particular in accordance with the second phase of the method according to invention. The software means can in particular comprise a computer program.

Moreover, the monitoring device 1 can form part of a welding installation 11. The installation also comprising a welding device 12 including a welding means 5, such as a laser welding means, and control unit 6. This control unit makes it possible in particular to define welding parameters, such as an advance, a power, a concentration of the laser beam 4, etc. The welding device makes it possible to weld together two elements 2 and 3, such as plates.

By virtue of the invention, it is possible to monitor, on line or in real time, beads welded by laser (or by another technology, for example arc welding). The invention applies equally well to the welding of metals as to plastics or thermoplastics.

Moreover, the method for monitoring quality according to the invention can also be carried out with other types and numbers of categories for the characterization of weld quality, as well as any other size of welded beads.

Moreover, the method according to the invention makes it possible:
to have a valid processing for metals and plastics welding applications,
to study appreciable variations only, while retaining all the necessary information (smoothing),
to have very significant robustness of quality rating (use of 21 explanatory variables),
to have an “intelligent” system: there is no threshold that has to be determined or modified by an operator,
to have a method which may be improved over time (enrichment of the database).
to limit the storage space (storage required: only the 21 explanatory variables mentioned previously).
to allow use on various production sites, with the same database (through an appropriate procedure for calibrating the sensor).

1-12. (canceled)

13. A method for monitoring the quality of a weld, comprising:
implementing a probabilistic statistical model, for determining a rating of the quality of the weld.

14. The monitoring method as claimed in claim 13, wherein the statistical model is a model of logistic regression.

15. The monitoring method as claimed in claim 13, wherein the implementing of the model makes it possible to rate the quality of the weld as compliant or as non-compliant or as uncertain.

16. The monitoring method as claimed in claim 13, wherein the model comprises a first module implemented to rate the quality of the weld as non-compliant or perhaps compliant, and a second module implemented to rate the quality of the weld as compliant or uncertain.

17. The monitoring method as claimed in claim 13, further comprising a first phase of defining the model for rating the quality of the weld and a second phase of using the rating model to rate the quality of the weld.

18. The monitoring method as claimed in claim 17, wherein the first phase uses profilometry data for the weld and/or temperature data for the weld, and the second phase uses profilometry data for the weld and/or temperature data for the weld.

19. The monitoring method as claimed in claim 17, wherein the first phase comprises:
carrying out weld trials;
acquiring data relating to the welds;
rating the quality of the weld trials;
smoothing the data, or smoothing the data carried out by breaks in mean;
compressing the smoothed data and extracting explanatory variables, or extracting explanatory variables corresponding to the quantiles characteristic of an empirical distribution function of the smoothed data; and
using the explanatory variables to define parameters of the model.

20. The monitoring method as claimed in claim 17, wherein the second phase comprises:
producing a weld;
acquiring data relating to the weld;
smoothing the data, or smoothing the data carried out by breaks in mean;
compressing the smoothed data and extracting explanatory variables, or extracting explanatory variables corresponding to quantiles characteristic of an empirical distribution function of the smoothed data;
using the model; and
rating the quality of the weld.

21. A non-transitory computer readable medium readable by a computer on which is recorded a computer program comprising computer program code means for implementing the method as claimed in claim 13.

22. A device for monitoring quality of a weld, comprising hardware and/or software means for implementing the method as claimed in claim 13.

23. A welding installation, comprising a monitoring device as claimed in claim 22 and a welding device.
